(19) United States
(12) Patent Application Publication
(10) Pub. No.: US 2013/0053095 A1
(43) Pub. Date: Feb. 28, 2013

(54) APPARATUS, METHOD AND SYSTEM FOR INTEGRATING MOBILE AND SATELLITE PHONE SERVICE

(71) Applicant: Robert Buckle, Reston, VA (US)

(72) Inventor: Robert Buckle, Reston, VA (US)

(21) Appl. No.: 13/601,782

(22) Filed: Aug. 31, 2012

Related U.S. Application Data
(60) Provisional application No. 61/529,642, filed on Aug. 31, 2011.

(51) Int. Cl. H04W 88/06

(52) U.S. Cl. 455/552.1

(57) ABSTRACT

A signal reinforcer device for a mobile phone provides communication with both a mobile communications network and a satellite communications network. The device includes an air interface to bi-directionally communicate with the mobile communications network through the mobile phone. A voice/data modem is configured to bi-directionally communicate with the satellite network via the antenna. A media changer operatively communicates with the voice/data modem and a network interface. An autonomous radio core processor operatively communicates with the air interface. A SIP server operatively communicates with the media changer and the autonomous radio core, and the SIP server operatively transmits a SIP call to provide bi-directional mobile phone communications between a mobile communications network and a satellite communication network. The system is implemented using a mobile phone, satellite and mobile communications network, gateway and router.

### RELATED APPLICATIONS

The present application claims priority to U.S. Provisional Patent Application Ser. No. 61/529,642 filed Aug. 31, 2011 and titled APPARATUS, METHOD, AND SYSTEM FOR INTEGRATING MOBILE AND SATELLITE PHONE SERVICE, the entire disclosure of which is incorporated herein by reference.

### FIELD OF THE INVENTION

The present disclosure relates generally to mobile phones, and more particularly to an apparatus, method, and system for integrating mobile and satellite telephone service.

### BACKGROUND

Various types of wireless communication systems are in global use, including a satellite phone network and a mobile or cellular phone network. Although satellite phones are well known, these types of devices possess a number of limitations regarding range of use, telephone number portability to non-satellite networks, extended development time, cost and the like. The range of use of existing satellite phones is likewise limited as these devices will not transmit or receive phone calls if the operator is located indoors. Accordingly, a human operator of a satellite phone must be located outdoors in order to access the satellite and to utilize the device for its intended purpose.

Existing satellite phones are also limited regarding telephone number portability to non-satellite networks. More specifically, telephone numbers assigned to a satellite handset device cannot be ported for use on non-satellite networks (e.g., public mobile networks). Conversely, mobile phones presently enjoy telephone number portability between different mobile networks.

Mobile phones have gained in consumer acceptance due to the portability and wide range of features available. In a competitive marketplace, the development time to introduce a new mobile phone into the market is relatively short, (e.g., two to three years). In comparison to mobile phones, satellite phones require a much longer development cycle. Such an extended development cycle is an impediment in a competitive business environment as new mobile devices are introduced to the market on a frequent basis.

Similar to satellite phones, mobile devices likewise posses a number of limitations that constrict their usage. For example, the user must be in the vicinity of a satellite tower associated with the network in order to receive and place calls. Dropped phone calls may occur while switching between cellular towers. If the user is located in a remote location outside the range of a cellular tower, then the mobile device will not function as intended.

A consumer in need of broad phone coverage would have to use both a cellular phone and a satellite phone, each having a separate phone number. Thus, there is a need in the art for an adapter that is compatible with a mobile phone and serves as an interface connecting a satellite associated with a satellite communications network with a cellular tower associated with a mobile phone network.

### SUMMARY OF THE DISCLOSURE

A signal reinforcer device for a mobile phone provides communication with both a mobile communications network and a satellite communications network. The device includes an air interface to bi-directionally communicate with the mobile communications network through the mobile phone. A voice/data modem is configured to bi-directionally communicate with the satellite network via the antenna. A media changer operatively communicates with the voice/data modem and a network interface. An autonomous radio core processor operatively communicates with the air interface. A SIP server operatively communicates with the media changer and the autonomous radio core, and the SIP server operatively transmits a SIP call to provide bi-directional mobile phone communications between a mobile communications network and a satellite communication network. The system is implemented using a mobile phone, satellite and mobile communications network, gateway and router. The method includes the steps of transmitting an input signal to the signal reinforcer device from a first communications network, receiving the input signal by the voice/data modem via the antenna and communicating the input signal to the SIP server. The method also includes the steps of processing the received input signal by the SIP server and transmitting an output signal from SIP server to the mobile phone via the air interface to provide bi-directional mobile phone communications between the mobile communications network and the satellite communication network.

An advantage of the present disclosure is that integrated mobile and satellite telephone service is realized through a communication device which is configured to be communicably connected with a standard mobile phone via a wireless interface. Another advantage of the present disclosure is that complete operational coverage (i.e., both indoor and outdoor) is enjoyed by an operator regardless of the physical location of the operator with respect to a communications satellite or cellular tower. A further advantage of the present disclosure is that the communications device may be utilized in a complementary manner to enhance existing mobile phone service to thereby provide a fully integrated service between mobile and satellite networks. Still a further advantage of the present disclosure is that due to the flexibility of the communications device, an operator will avoid having to purchase a new mobile device, obtain a new mobile phone service provider, or procure a new phone number to utilize these at least one embodiment of the present application. Yet a further advantage of the present disclosure is that an operator has greater market choice in selecting a mobile service provider since their present mobile phone number may be utilized. Still yet another advantage of the present disclosure is that the mobile phone may slidably engage with the communication device for convenience. Furthermore, because the mobile phone and the communication device communicate wirelessly, the mobile phone may be removed from the apparatus and still operate even during a call as there is no physical connection for communication operations therebetween.

Other features and advantages of the present disclosure will become readily appreciated as the same becomes better understood after reading the following description when considered in conjunction with the accompanying drawings.

### DESCRIPTION OF THE DRAWINGS

FIG. 1 is a systems diagram of an integrated wireless phone communications network, according to the present disclosure.

FIG. 2 is a block diagram of an adapter device for use with the communications network of FIG. 1.

FIG. 3 is a diagram illustrating use of the adapter device of FIG. 2.

FIG. 4 is another diagram illustrating use of the adapter device of FIG. 2.

FIG. 5 yet another diagram illustrating use of the adapter device of FIG. 2.

FIG. 6 is a method of facilitating communications within an integrated mobile communications network using the adapter device of FIG. 2.

FIG. 7 is a diagrammatic view of a mobile satellite phone communication system.

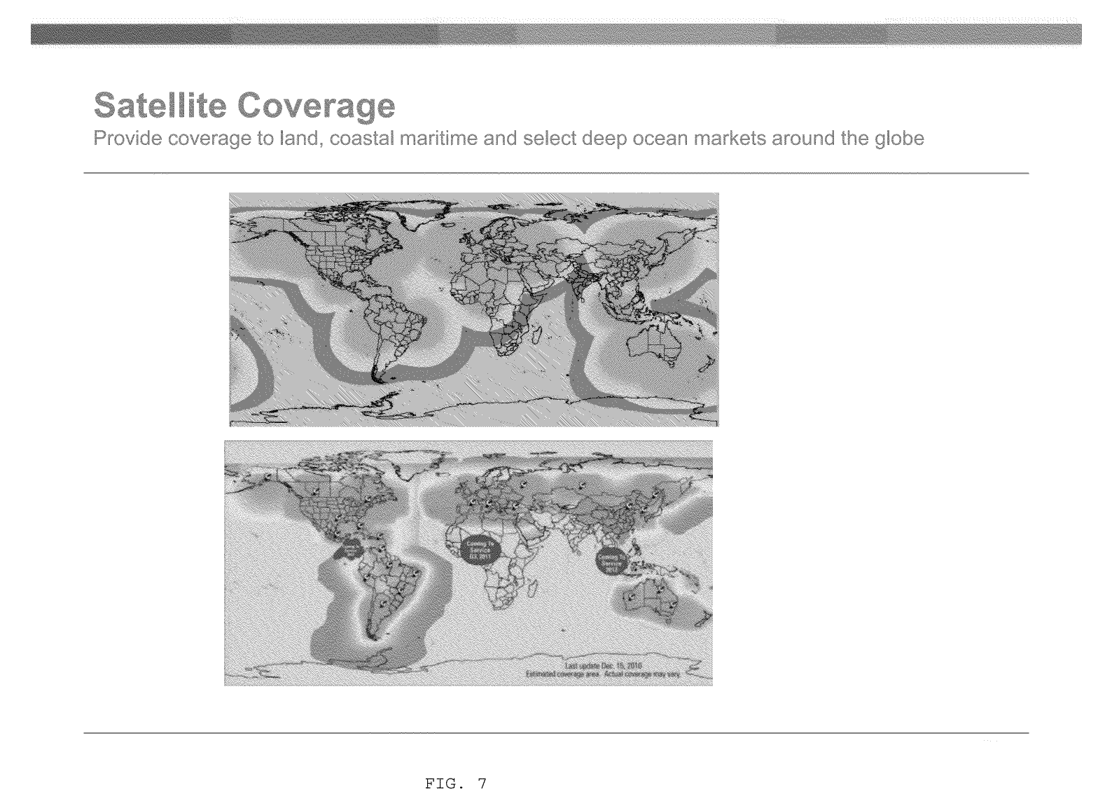

### DESCRIPTION

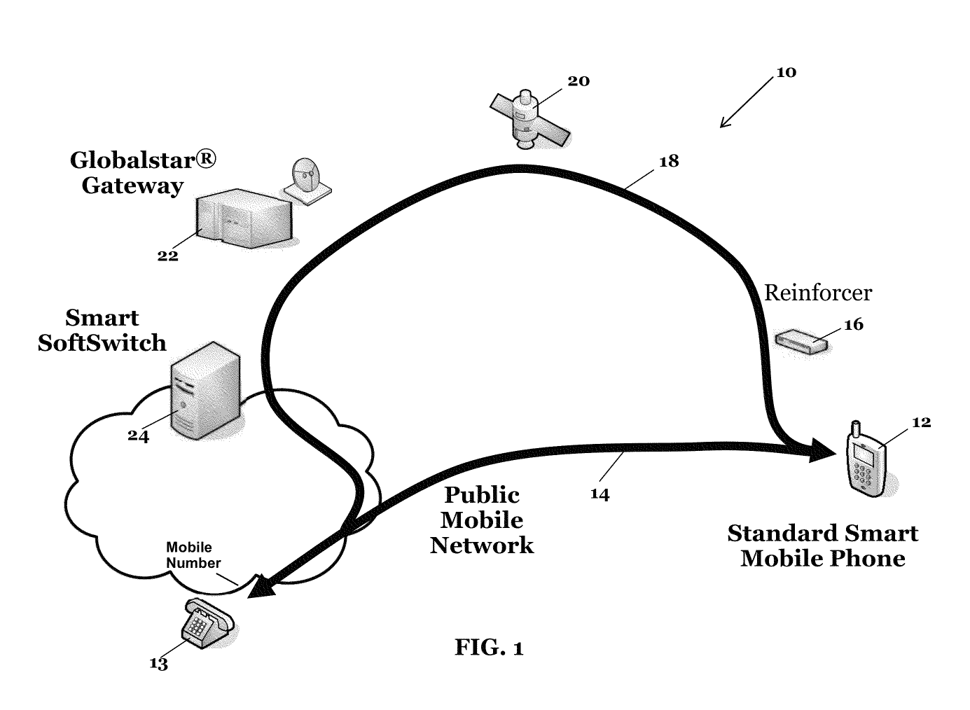

Referring to FIG. 1, a systems diagram of an integrated wireless phone communications network is illustrated. The integrated wireless phone communications network bridges the gap between cellular phone coverage via a network of cellular towers and satellite phone coverage via a network a satellites.

The system 10 includes a mobile phone 12, which in this example is a “smart” phone. Various examples of a smart phone include iPhone®, Blackberry®, Android® or the like. The mobile phone 12 is capable of wireless communications via a public mobile communications network 14. The public mobile communications network 14 includes a plurality of terrestrial based cellular towers geographically positioned in order to provide cellular phone coverage within range of the cellular tower. A mobile number is associated with the mobile phone 12 for identification purposes, as is conventional. The system 10 also includes an adapter, also referred to as a signal reinforcer 16, in operative communications with the mobile phone 12 in a manner to be described.

The system 10 also includes a satellite communications network 18. The satellite communications network 18 includes a plurality of communication satellites 20 selectively positioned in space around a geographic region in order to provide satellite phone coverage via the satellite communications network 18.

The system 10 further includes a gateway or router 22 that processes and routes the phone calls throughout the cellular 14 and satellite communication networks 18. The gateway 22 includes a processor and associated software that enables users to roam between networks by seamlessly handing off a live call from one network to another network.

The system 10 also includes a smart soft switching router 24 that enables active calls to be switched from any public or private fixed or mobile network to any other type of public or private fixed or mobile network without dropping the call. Advantageously, the smart switch 24 can operate over any public communications network without special agreements or arrangements. As such, the selection of which network operator to use to interconnect with for outbound calls is very flexible. For example, an inbound call may come in for a subscriber across a first network, but the call can be switched across a second network to the user's phone. In another example, an outbound call may be transmitted by the subscriber across the first network, and may be switched out to the PSTN via a second network. Advantageously, one service provider could provide the terrestrial connection, while another service provider can provide the satellite connection. It is contemplated that access to the terrestrial connection or satellite connection could be offered through a subscription service.

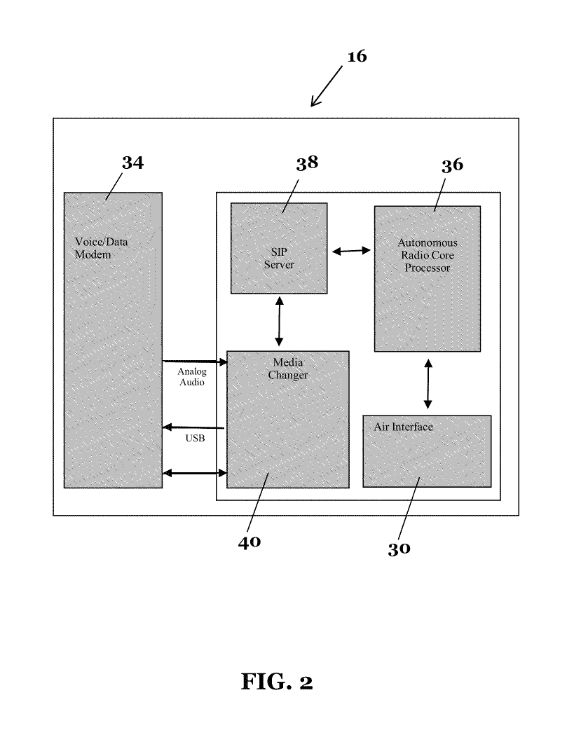

Referring to FIGS. 2-6, adaptor or the signal reinforcer 16 is described which allows an operator to use a general mobile phone 12 with the communication networks described herein to achieve integrated mobile and satellite phone service.

The signal reinforcer 16 includes a case having a generally rectangular base portion 26 and a holder portion 28 integrally formed thereto. The holder portion 28 may be configured for receiving a mobile phone through an open end. The shape of the holder portion 28 provides support for the mobile phone 12 and allows the control and display functions of the mobile phone 12 to be visible and accessible.

If the mobile phone 12 is received within the holder portion 28 while the mobile phone 12 is being operated, the mobile phone 12 may be slidably removed from the holder portion 28 without interruption to present communication operations or service generally as the mobile phone 12 wirelessly communicates with the signal reinforcer 16. With the aforementioned configuration, an operator may communicate with the satellite communications network 18 utilizing the signal reinforcer 16 while indoors if the device is situated near a window or outdoors.

To achieve the foregoing communication function, the signal reinforce 16 includes an air interface 30 which is configured to bi-directionally communicate with a mobile phone 12 wirelessly. The air interface 30 may communicate with any mobile network, including but not limited to: 2G, 3G, LTE or 4G or the like. With the aforementioned configuration, the signal reinforcer 16 provides functionality similar to that of a cellular phone tower. Additionally, the air interface 30 may include other features such as WiFi or Bluetooth functionality or the like.

Additionally, the signal reinforcer 16 includes an antenna 32 and a voice/data modem 34, which are configured to bi-directionally facilitate communications with a satellite network 18 via the antenna 32.

The antenna 32 in an example may be fixed to the base portion 26 of the signal reinforcer 16. Further, in another example, the antenna 44 may be separable from the signal reinforcer 16.

The signal reinforcer 16 operatively communicates with a satellite communications network 18. An example of a satellite communications network 18 is Globalstar's® first generation satellite network. To bidirectionally communicate with the satellite network of this example, the voice/data modem 34 of the signal reinforcer 16 may be a Globalstar voice/data modem® (model 1720 or 1700).

The signal reinforcer 16 also includes an autonomous radio core processor (ARN Core) 36 which provides all of the routing tables. The autonomous radio core processor 36 communicably connects with the air interface 30 and includes integrated support for hosting one or more value added applications. An example of value added user applications include SMS texting, email, internet web browsing, blue force tracking, or a Session Initiation Protocol (SIP) server or the like. Further, the communication device may additionally include a dynamic web cash or an email server or the like.

The signal reinforcer 16 additionally includes a media changer 40 which is communicably connected to the voice/data modem 34. The media changer 40 enables the signal reinforcer 16 to use various types of network interfaces.

The signal reinforcer 16 may also include a Session Initiation Protocol (SIP) server 38 situated within the signal reinforcer 16 to enable a SIP client of a user element (UE) or mobile phone 12 to use a standard high quality/high speed (i.e. 87.2 Kbps) G711 (u & A Law) or G729 session with the signal reinforcer 16. The SIP client of the mobile phone 12 may communicably connect to the SIP server 38 of the signal reinforcer 16 via a WiFi access point of the air interface 30.

As an example, when an outbound call is made from the mobile phone, the call is routed to the SIP server 38. Thereafter, the SIP server 38 makes an outbound call to the voice/data modem 34 via the media changer 40, such as by using an analog and USB interface. Conversely, when an inbound call is received by the voice/data modem 34, the SIP server 38 receives the inbound call and initiates an outbound call to the SIP client of the mobile phone 12, such as via the WiFi access point associated with the air interface 30. Further, the media changer performs a conversion function from digital SIP to analog audio.

The SIP server 38 may be situated within the apparatus to provide enhanced voice quality, otherwise heavy compression would be required to fit the SIP stream into the non-transparent 7.2 k data async channel. More specifically, all calls from the human operators mobile phone would need to be converted into SIP VOIP, sent over a satellite network as data, and transmitted subsequently through the internet to a remote SIP server. Further, the remote SIP server may require direct interconnection to the PSTN and accordingly may require a separate billing platform.

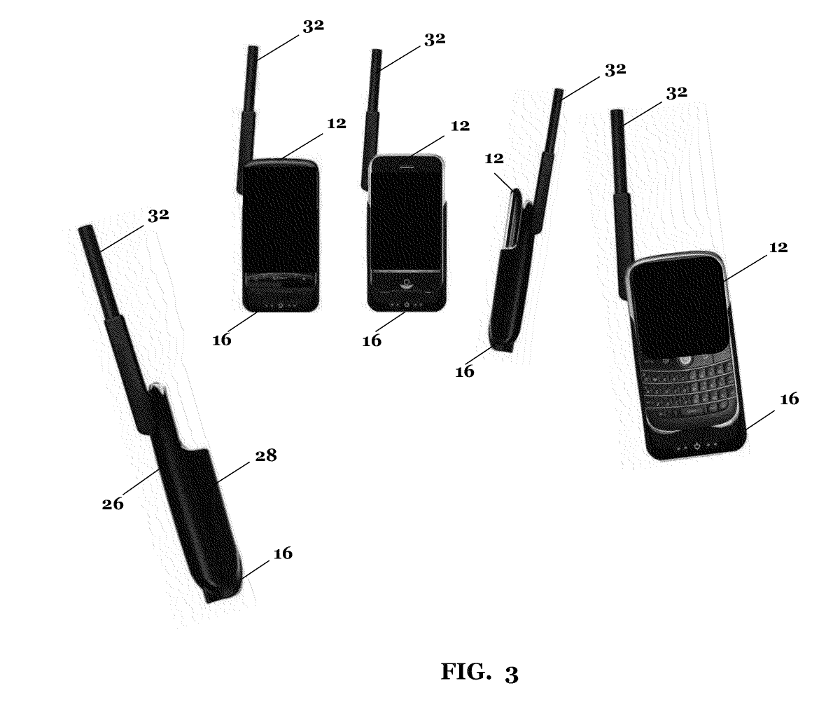

As illustrated in FIGS. 3-5, the signal reinforcer 16 may be a standalone device that integrates a phone 12 and signal reinforcer 16 into one unit. Further, the signal reinforcer 16 may be situated within a mobile phone 12.

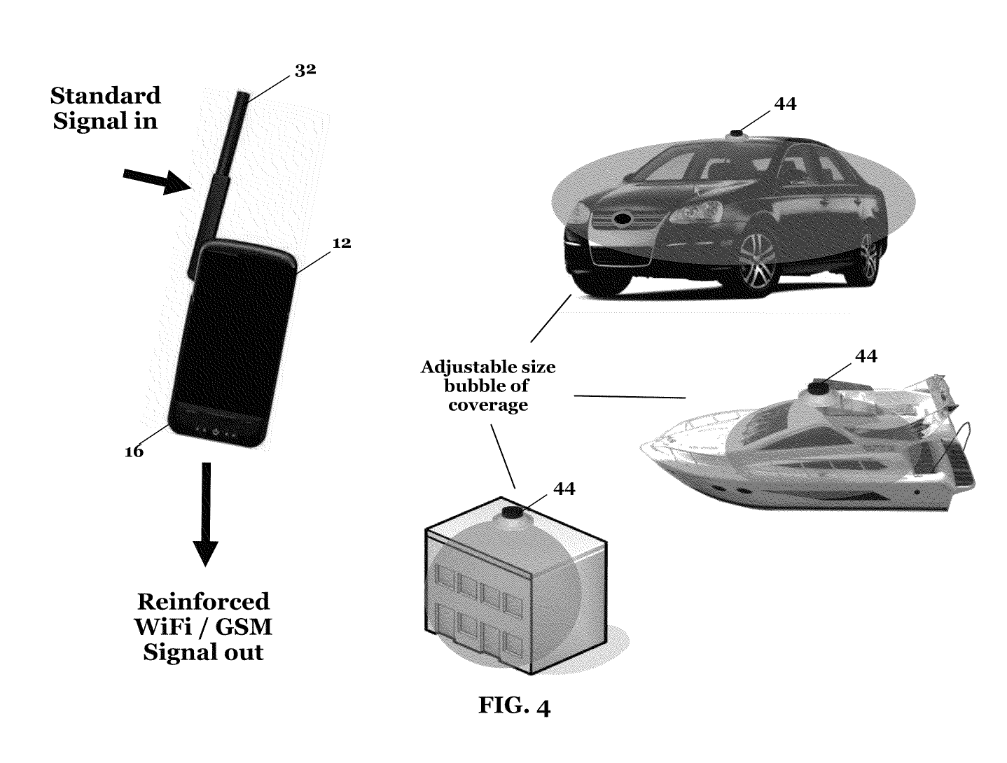

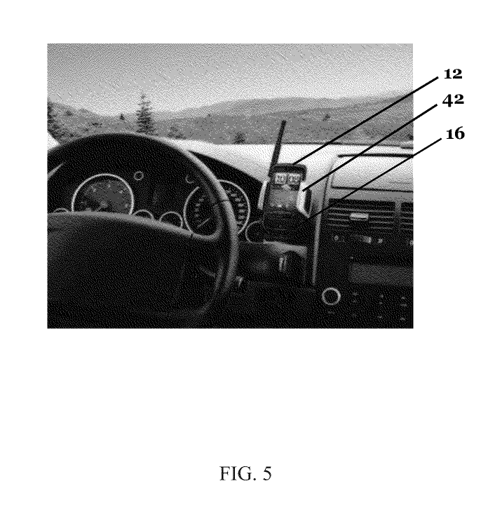

The signal reinforcer 16 may include additional features, such as security functionality to restrict non-authorized users from operating the device. Additionally, the base portion 26 of the signal reinforcer 16 may include an orifice therein for receiving a media or power cable which physically interfaces with the mobile phone 12. Referring to FIGS. 4 and 5, the signal reinforcer 16 may include an adapter kit 42 for providing a bubble of connectivity within a vehicle, such as an automotive vehicle, a boat or the like. The adapter kit 42 may include a connector for charging a battery associated with either the phone or the signal reinforcer 16. The adaptor kit 42 may also include the hardware and software for providing a hands free use of the phone 12. The adaptor kit 42 may be removable from the vehicle, allowing the operator the freedom to use the phone 12 outside of the vehicle. The adapter kit 42 may operatively be in communication with an external antenna 44 positioned on the vehicle to enhance satellite reception. As a result, the adapter kit 42 may be positioned anywhere in the vehicle.

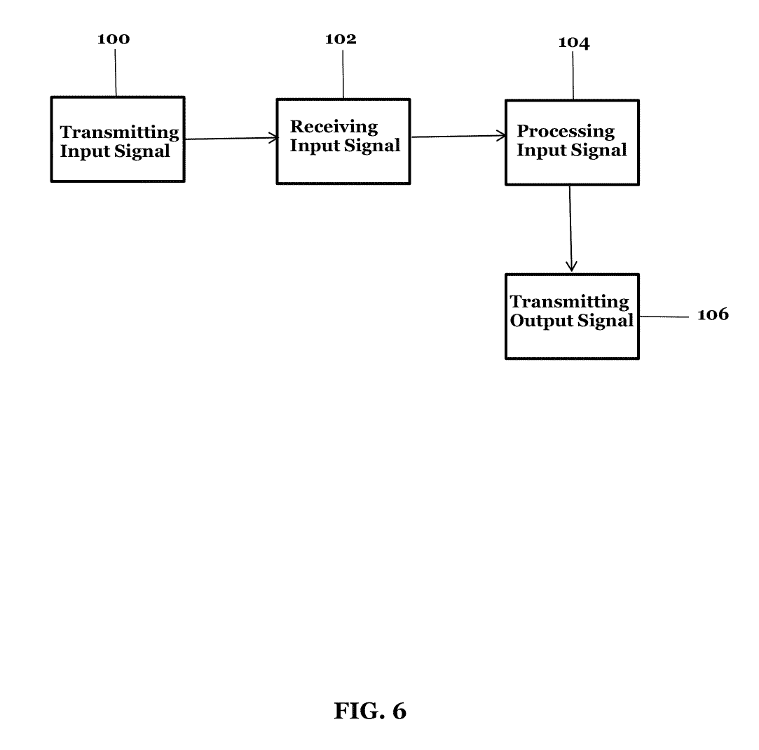

Referring to FIG. 6, a method of providing integrated communications between networks is provided. The method begins in block 100 with the step of transmitting an input signal to a signal reinforcer 16 from a first communications network. An example of a first communications network is the satellite communications network 18, as previously described. The signal is received by the voice/data modem 34 via the antenna 32 of the signal reinforcer 16. The received signal is thereafter answered by the SIP server 38.

The methodology advances to block 102 and the signal is processed within the SIP server 38 associated with the signal reinforcer 16, as previously described. The methodology advances to block 104 and an output signal is transmitted by the SIP server 38 to a SIP client associated with the mobile phone 12, such as through a wifi access point of the air interface 30.

The coverage of the communications network may be selectively determined based on the type of network. Advantageously, the phone can switch between satellite and mobile communications networks without interruption to the call and provide enhanced mobile coverage regardless of the prevailing type of network.

The present disclosure has been described in an illustrative manner. It is to be understood that the terminology which has been used is intended to be in the nature of words of description rather than of limitation. Many modifications and variations of the present example are possible in light of the above teachings. Therefore, within the scope of the appended claims, the present disclosure may be practices other than as specifically described.

What is claimed is:

1. A signal reinforcer device for a mobile phone that is in communication with both a mobile communications network and a satellite communications network, said signal reinforcer device comprising:
an air interface configured to bi-directionally communicate with the mobile communications network through the mobile phone;
an antenna;
a voice/data modem configured to bi-directionally communicate with the satellite network via the antenna;
a media changer operatively in communication with the voice/data modem and configured to communicate with a network interface;
an autonomous radio core processor operatively in communication with the air interface; and
a SIP server operatively in communication with the media changer and the autonomous radio core, wherein the SIP server operatively transmits a SIP call, and the media changer is configured to perform a conversion function between digital SIP to analog audio to provide bi-directional mobile phone communications between a mobile communications network and a satellite communication network.

2. The signal reinforcer device of claim 1 wherein the air interface communicates wirelessly via a wireless mobile network.

3. The signal reinforcer device of claim 1 wherein the air interface includes WiFi connectivity.

4. The signal reinforcer device of claim 1 wherein the satellite network is a low-earth-orbit (LEO) satellite network.

5. The signal reinforcer device of claim 1 wherein the media changer converts between digital SIP and analog audio.

6. The signal reinforcer device of claim 1 wherein the autonomous radio core processer is operatively in communication with an email server.

7. The signal reinforcer device of claim 1 wherein the autonomous radio core processer is operatively in communication with a dynamic web cash.

8. A method of providing integrated mobile phone communications between a mobile communications network and a satellite communications network, said method comprising the steps of:
providing a mobile phone configured to be operatively in communication with the mobile communications network;
providing a signal reinforcer device operatively connected to the mobile phone, wherein the signal reinforcer device includes:
a. an air interface configured to bi-directionally communicate with the mobile communications network through the mobile phone,
b. an antenna,
c. a voice/data modem configured to bi-directionally communicate with the satellite network via the antenna,
d. a media changer operatively in communication with the voice/data modem and configured to communicate with a network interface,
e. an autonomous radio core processor operatively in communication with the air interface, and
f. a SIP server operatively in communication with the media changer and the autonomous radio core, wherein the SIP server operatively transmits a SIP call, and the media changer is configured to perform a conversion function between digital SIP to analog audio;
transmitting an input signal to the signal reinforcer device from a first communications network;
receiving the input signal by the voice/data modem via the antenna and communicating the input signal to the SIP server;
processing the received input signal by the SIP server;
transmitting an output signal from SIP server to the mobile phone via the air interface to provide bi-directional mobile phone communications between the mobile communications network and the satellite communication network .

9. The method of claim 8 wherein the first communications network is a satellite communications network.

10. The method of claim 8 further including the step of automatically switching between the satellite communications network and the mobile communications network.

11. The method of claim 8 wherein the air interface communicates wirelessly via a wireless mobile network.

12. The method of claim 8 wherein the air interface includes WiFi connectivity.

13. The method of claim 8 wherein the satellite network is a low-earth-orbit (LEO) satellite network.

14. The method of claim 8 wherein the media changer converts between digital SIP and analog audio.

15. The method of claim 8 wherein the autonomous radio core processer is operatively in communication with an email server.

16. A system for providing integrated communications between a mobile communication network and a satellite communication network, comprising:
a mobile phone configured to be operatively in communication with the mobile communications network;
a signal reinforcer device operatively connected to the mobile phone, wherein the signal reinforcer device includes:
a. an air interface configured to bi-directionally communicate with the mobile communications network through the mobile phone,
b. an antenna,
c. a voice/data modem configured to bi-directionally communicate with the satellite network via the antenna,
d. a media changer operatively in communication with the voice/data modem and configured to communicate with a network interface,
e. an autonomous radio core processor operatively in communication with the air interface, and
f. a SIP server operatively in communication with the media changer and the autonomous radio core, wherein the SIP server operatively transmits a SIP call, and the media changer is configured to perform a conversion function between digital SIP to analog audio;
a gateway operatively in communication with the satellite communications network and mobile communications network to process and route signals from the mobile phone.

17. The system of claim 16 further comprising a router operatively in communication with the gateway to switch signals between networks.

18. The system of claim 16 further including the step of automatically switching between the satellite communications network and the mobile communications network.

19. The system of claim 16 wherein the air interface includes WiFi connectivity.

20. The system of claim 16 wherein the satellite network is a low-earth-orbit (LEO) satellite network.
